(19) United States
(12) Patent Application Publication
(10) Pub. No.: US 2026/0276011 A1
(43) Pub. Date: Sep. 17, 2026

(54) STATIC FORCE AMPLIFIER

(71) Applicant: Canrig Robotic Technologies AS, Houston, TX (US)

(72) Inventors: Kjetil Naesgaard, Roeyneberg (NO); Tor Inge Berge, Stavanger (NO); PER GUNNAR BJOLAND, HUNDVÅG (NO)

(21) Appl. No.: 19/082,008

(22) Filed: Mar. 17, 2025

(51) Int. Cl. F15B 13/10; E21B 19/16; F15B 1/04; F15B 15/20

(52) U.S. Cl. CPC F15B 13/10; E21B 19/16; F15B 1/04; F15B 15/20

(57) ABSTRACT

An actuation system includes one or more two-stage actuator units and a hydraulic booster unit fluidly coupled to the one or more two-stage actuator units. The one or more two-stage actuator units includes an electrical motor, a ball screw coupled to the electrical motor, and a clamping body coupled to the ball screw. The hydraulic booster unit includes an accumulator configured to contain a fluid, an amplifier body having a first volume and a second volume fluidly coupled to the accumulator, and a screw actuator disposed within the first volume and the second volume.

### TECHNICAL FIELD

Embodiments herein are generally directed to electrical and hydraulic actuators and operations performed in conjunction with well drilling operations and, more particularly, to an electrical actuator with static force amplification for use in clamping operations.

### BACKGROUND

Actuators are mechanical devices that convert energy into motion and are used primarily to control machines and allow parts to move—e.g., in a linear, rotary, or oscillatory manner. Most actuators are categorized as hydraulic, pneumatic, or electric and function to generate mechanical power or movement from compressed fluid, compressed gas, or electricity input, respectively. In general terms, hydraulic actuators are commonly used when high overall force and power density are needed, such as in construction and oil/gas industries, while pneumatic actuators and electric actuators have lower power/strength capabilities. As will be appreciated, each type of actuator has pros and cons.

In the well drilling industry, many operations are performed by actuators, including for example, lifting, pushing/pulling, moving, rotating, clamping (securing), etc. In one example, clamping systems and devices are used in well drilling operations primarily to secure, move, stabilize, or otherwise manipulate workpieces, such as well pipe/casing.

While hydraulic clamping systems are robust and powerful, they are generally limited by having low speed and low accuracy. A substantial increase in power requirements and incorporation of additional complex and costly controlling functionality would be required to increase speed and accuracy to any practical acceptable level. Although clamping systems may theoretically use electric actuators in an attempt to achieve the clamping forces provided by a hydraulic actuator, such electric actuators would be costly, large and require a large motor to generate these high clamping forces.

Accordingly, there is a need for an improved actuator configured and capable of providing both the high power and pressure capabilities/features of hydraulic actuators as well as the high speed and accuracy capabilities/features of electric actuators. There is also a need for such improved actuators for use in clamping systems and operations in various industries, including the well drilling industry.

### SUMMARY

This disclosure relates to electrical actuators with static force amplification for use in clamping operations performed in conjunction with well drilling operations.

In some examples, a hydraulic booster unit for applying pressure to hydraulic fluid disposed within an actuation system is provided. The hydraulic booster unit includes an amplifier body. The amplifier body includes an actuator having a first end disposed within a first volume and a second end disposed within a second volume, a first fluid connection coupled to the first volume and configured to selectively provide fluid connection between the first volume and an actuation system, the first fluid connection including a check valve, a second fluid connection coupled to the second volume and configured to provide fluid connection between the second volume and the actuation system, and a motor configured to axially move the actuator along a length of the amplifier body and apply pressure to hydraulic fluid within the second volume. The hydraulic booster unit also includes an accumulator configured to hold hydraulic fluid and supply hydraulic fluid to the first volume.

Any single one or any combination of the following features may be used with the examples above. The hydraulic booster unit may also include a check valve disposed within the first volume and configured to allow the fluid from the accumulator to flow from the first volume into a plurality of fluid lines of an actuation system. The check valve includes a valve body having a valve inner head on a first valve end of a valve stem, and a spring disposed about the valve body and in contact with a valve protrusion on a second valve end of the valve stem, the second valve end disposed within the first volume. The actuator includes a screw body having a first end disposed within the first volume and a second end disposed within the second volume. The actuator is coupled to a secondary check valve. The secondary check valve is disposed in a cavity of the actuator on an opposite end of the check valve. The secondary check valve is configured to allow the fluid to flow into the cavity.

In other examples, an actuation system is provided. The actuation system includes one or more two-stage actuator units and a hydraulic booster unit fluidly coupled to the one or more two-stage actuator units. The one or more two-stage actuator units includes an electrical motor, a ball screw coupled to the electrical motor, and a clamping body coupled to the ball screw. The hydraulic booster unit includes an accumulator configured to contain a fluid, an amplifier body having a first volume and a second volume fluidly coupled to the accumulator, and a screw actuator disposed within the first volume and the second volume.

Any single one or any combination of the following features may be used with the examples above. The hydraulic booster unit may also include a check valve disposed within the first volume and configured to allow the fluid from the accumulator to flow from the first volume into a plurality of fluid lines of the actuation system. The check valve may include a valve body having a valve inner head on a first valve end of a valve stem, and a spring disposed about the valve body and in contact with a valve protrusion on a second valve end of the valve stem, the second valve end disposed within the first volume. The screw actuator may include a screw body having a first end disposed within the first volume and a second end disposed within the second volume. The screw actuator may be coupled to a booster motor configured to translate the screw body axially along a length of the amplifier body. The screw actuator may include a pressing body having a pressing surface disposed on the second end. The booster motor may be configured to rotate a screw body such that the pressing body applies a force onto a fluid disposed in the second volume.

In still other examples, a method of providing high pressure to a fluid system is provided. The method includes extending a clamping surface of a clamping body of a clamping unit to a clamping position, activating a hydraulic booster unit to increase a clamping pressure at the clamping surface, after a clamping period, reducing the clamping pressure at the clamping surface using the hydraulic booster unit, and retracting the clamping surface of the clamping unit to a pre-clamping position.

Any single one or any combination of the following features may be used with the examples above. Extending the clamping surface of the clamping unit to the clamping position may include using a clamping motor to rotate a ball screw to extend the clamping body to a pre-clamping position. Extending the clamping surface of the clamping unit to the clamping position may include supplying a fluid from an accumulator to fill a fluid cavity to extend the clamping body to the clamping position. Activating a hydraulic booster unit to increase a clamping pressure at the clamping surface may include using a booster motor of the hydraulic booster unit to rotate a screw actuator of the hydraulic booster unit to apply a force onto a fluid disposed within a second volume of the hydraulic booster unit, the second volume fluidly coupled to the clamping body of the clamping unit. Activating a hydraulic booster unit to increase a clamping pressure at the clamping surface may include closing of a valve opening of a check valve disposed within the hydraulic booster unit to create a closed fluid system. Activating a hydraulic booster unit to increase a clamping pressure at the clamping surface may include increasing a pressure of a fluid within the closed fluid system to increase the pressure applied at the clamping surface.

Other technical features may be readily apparent to one skilled in the art from the following figures, descriptions, and claims.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and the present disclosure may admit to other equally effective embodiments.

FIG. 1, there is illustrated a representative simplified front view of a rig being utilized for a subterranean operation, in accordance with certain embodiments;

FIG. 2 is a representative perspective view of an iron roughneck in a fully stowed position, in accordance with certain embodiments;

FIG. 3 is a representative partial cross-sectional top view of a wrench assembly of an iron roughneck showing hydraulic actuators of a torque wrench, in accordance with certain embodiments;

FIG. 4 illustrates a schematic view of an actuation system, according to certain embodiments;

FIG. 5A illustrates a perspective, cross-sectional view of a two-stage actuator unit, according to certain embodiments;

FIG. 5B illustrates a schematic, cross-sectional top view of the two-stage actuator unit of FIG. 5A, according to certain embodiments;

FIG. 6 illustrates a flow diagram of a method of clamping using a two-stage actuator unit, according to certain embodiments;

FIGS. 7A, 7B, 7C, 7D, and 7E illustrate a two-stage actuator unit having a hydraulic booster unit undergoing the method of FIG. 6, according to certain embodiments;

FIG. 8A illustrates a simplified schematic view of a hydraulic booster unit, according to certain embodiments;

FIG. 8B illustrates a schematic, cross-sectional view of a portion of the hydraulic booster unit of FIG. 8A, according to certain embodiments;

FIG. 8C illustrates a schematic, cross-sectional view of a portion of the hydraulic booster unit of FIG. 8A, according to certain embodiments;

FIG. 8D illustrates a schematic, cross-sectional view of an alternative check valve mechanism and arrangement which may be used in the hydraulic booster system of FIG. 8A, according to certain embodiments;

FIG. 9 illustrates a flow diagram of a method of providing high pressure to a fluid system using a hydraulic booster unit, according to certain embodiments; and

FIGS. 10A, 10B, 10C, 10D, 10E, and 10F illustrate an actuation system having a hydraulic booster unit undergoing the method of FIG. 9, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments herein are generally directed to actuation systems and equipment utilized and operations performed in conjunction with well drilling operations and, more particularly, to systems and methods for clamping or securing a pipe or other component for drilling operations using a two-stage (or two-phase) or hybrid actuator and system.

In general terms, the present disclosure is directed to an actuation system for applying mechanical force(s) to a target object using a two-stage or hybrid actuator. The actuator is configured as a combination of an electric actuator and a hydraulic actuator. In the first stage, activation of an electric motor generates a first force that causes the actuator cylinder/body to move towards the target object. Upon contact (or at least close proximity) with the target object, the second stage applies a second force—a “static” and substantial force—to the target body. This force is generated by the hydraulic actuator via hydraulic pressure acting on the actuator cylinder/body. In other words, electrical actuation (low force) firstly drives the cylinder/body toward and into contact with the target body, and hydraulic actuation (high force) secondly applies a high force against the cylinder/body and thusly the target object. This second stage force can be referred to as “static force amplification” because the actuator is already (or nearly) in contact with the cylinder/body and the force applied is increased and results in a clamping force (or pressure) against the target object with no (or nominal) movement of the target object. As will be appreciated, the two-stage or hybrid actuator described herein may also be referred to as an electrical actuator with static force amplification (or an electro-mechanical actuator with hydraulic static force amplification).

One of the benefits of the actuator system and actuator of the present disclosure is the capability to quickly move (using low force/power) the actuator cylinder/body from an unclamped position (a distance away from the target object) to an extended or pre-clamping position (in contact with or close to the target object) and/or accurately position the actuator cylinder into a desired placement.

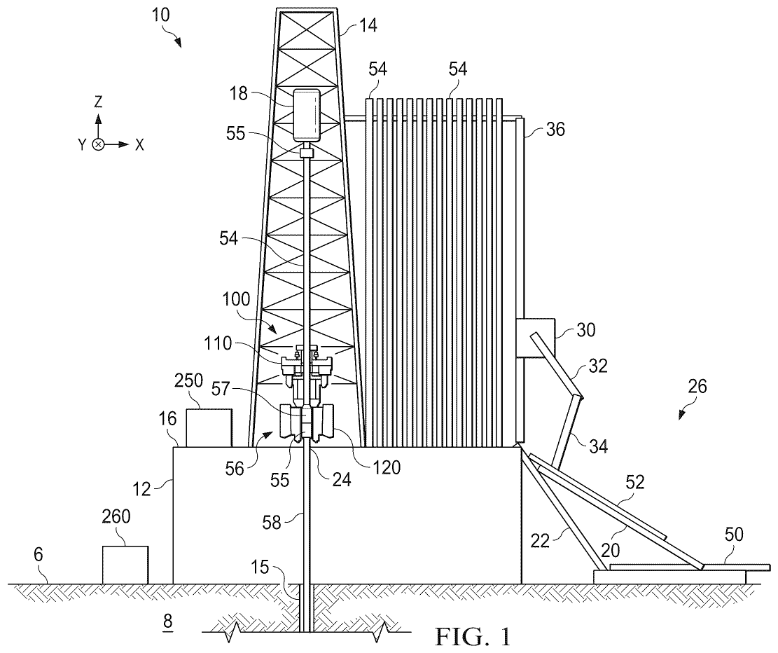

Now turning to FIG. 1, there is illustrated a representative simplified front view of a rig 10 being utilized for a subterranean operation (e.g., tripping in or out a tubular string 58 to or from a wellbore 15), in accordance with certain embodiments. The rig 10 can include a platform 12 with a rig floor 16 and a derrick 14 extending up from the rig floor 16. The derrick 14 can provide support for hoisting the top drive 18 as needed to manipulate tubulars. A catwalk 20 and a V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20.

A pipe handler 30 with articulating arms 32, 34 can be used to grab the tubular segment 52 from the catwalk 20 and transfer the tubular segment 52 to the top drive 18, a fingerboard 36, the wellbore 15, etc. However, it is not required that a pipe handler 30 be used on the rig 10. The top drive 18 may be configured to transfer tubulars directly between the catwalk 20 and a well center 24 on the rig floor 16 (e.g., using an elevator coupled to the top drive). It is also not required that a catwalk 20 be used to transfer tubulars to/from the horizontal storage area 26. On or more pipe handlers 30 with articulating arms can be used to collect or deliver tubulars between the horizontal storage area 26 and other locations on the rig 10.

As used herein, “tubular” refers to an elongated cylindrical tube and can include any of the tubulars manipulated around the rig 10, such as tubular segments 50, 52, tubular stands 54, and tubular string 58, but not limited to the tubulars shown in FIG. 1. Therefore, in this disclosure, “tubular” is synonymous with “tubular segment,” “tubular stand,” and “tubular string,” as well as “pipe,” “pipe segment,” “pipe stand,” “pipe string,” “casing,” “casing segment,” or “casing string.”

The tubular string 58 can extend into the wellbore 15, with the wellbore 15 extending through a surface 6 into a subterranean formation 8. When tripping the tubular string 58 into the wellbore 15, tubular stands 54 are sequentially added to the tubular string 58 to extend the length of the tubular string 58 into the earthen formation 8. FIG. 1 shows a land-based rig. However, it should be understood that the principles of this disclosure are equally applicable to offshore rigs where “offshore” refers to a rig with water between the rig floor and the earth surface 6. When tripping the tubular string 58 out of the wellbore 15, the tubular stands 54 are sequentially removed from the tubular string 58 to reduce the length of the tubular string 58 in the wellbore 15. Similarly, when tripping the tubular string 58 into the wellbore 15, the tubular stands 54 are sequentially added to the tubular string 58 to increase the length of the tubular string 58 in the wellbore 15.

When tripping the tubular string 58 into the wellbore 15, the pipe handler 30 (or other handling device) can be used to deliver the tubular stands 54 from the fingerboard 36 to a well center on the rig floor 16 in a vertical orientation and hand the tubular stand 54 off to an iron roughneck system 100 or the top drive 18. When tripping the tubular string 58 out of the wellbore 15, the pipe handler 30 (or another handling device) can be used to remove the tubular stand 54 from the well center in a vertical orientation and receive the tubular stand 54 from the iron roughneck system 100 or the top drive 18 and deliver it to the fingerboard 36. The iron roughneck system 100 can make a threaded connection (identified as reference numeral 56) between a tubular stand 54 being added and the tubular string 58. A spinner assembly 110 can engage a body of the tubular stand 54 to spin a pin end 57 of the tubular stand 54 into a threaded box end 55 of the tubular string 58, thereby threading the tubular stand 54 into the tubular string 58. A torque wrench 140 of the roughneck system 100 can provide a desired torque to the threaded connection, thereby completing the connection. This process can be reversed when the tubular stands 54 are being removed from the tubular string 58. In addition, the roughneck system 100 and the pipe handler 30 can be used to connect individual tubulars 52 together to form the tubular stands 54 and vice versa.

A rig controller 250 can be used to control the rig 10 operations including controlling various rig equipment, such as the pipe handler 30, the top drive 18, the iron roughneck system 100, and power systems 260. The rig controller 250 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation). A portion of the rig controller 250 can also be distributed around the rig 10, such as having a portion of the rig controller 250 in the pipe handler 30, in the iron roughneck system 100, in the power systems 260, or around the rig 10.

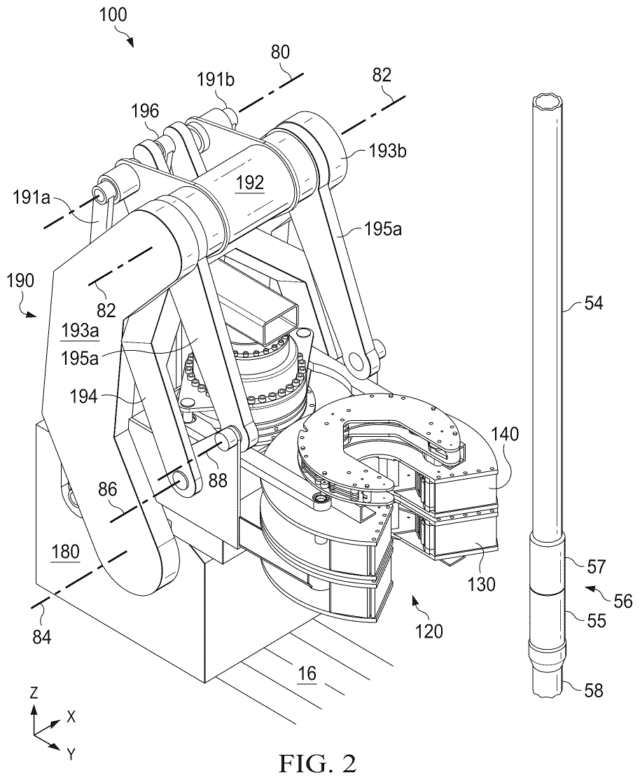

FIG. 2 is a representative perspective view of the iron roughneck system 100 in a fully stowed position, in accordance with certain embodiments. In a non-limiting embodiment, the iron roughneck system 100 can include a base 180 that is coupled to a wrench assembly 120 by a positioning system 190, which can move the wrench assembly 120 between a fully stowed position (as shown in FIG. 2) and several deployed positions. Drive arms 193a, 193b can be rotationally driven about an axis 84 by a motor (not shown) which can be disposed in the base 180. The drive arms 193a, 193b can be rotationally coupled to the base 180 to pivot about the axis 84 at one end and coupled at an opposite end to opposite ends of a rotational coupling 192.

The rotational coupling 192 can be rotationally coupled to the ends of the drive arms 193a, 193b to rotate about the axis 82. The rotational coupling 192 can be rotationally coupled to one end of first links 191a, 191b, with the opposite ends of the first links 191a, 191b rotationally coupled to the base 180. The rotational coupling 192 can be rotationally fixed to one end of third links 195a, 195b, with the third links 195a, 195b being rotationally coupled to the wrench assembly 120 on opposite sides of the wrench assembly 120 at an axis 88. A second link 194 can be rotationally coupled at one end to opposite sides of the wrench assembly 120 at an axis 86, with the other end of the second link 194 rotationally coupled to one end of a fourth link 196. An opposite end of the fourth link 196 can be rotationally coupled to the base 180. When the drive arms 193a, 193b are rotated clockwise about the axis 84, the wrench assembly 120 can be moved away from a stowed position toward a deployed position and held in a horizontal orientation by the positioning system 190. When the drive arms 193a, 193b are rotated counterclockwise about the axis 84, the wrench assembly 120 can be moved away from a deployed position toward the stowed position and held in the horizontal orientation by the positioning system 190.

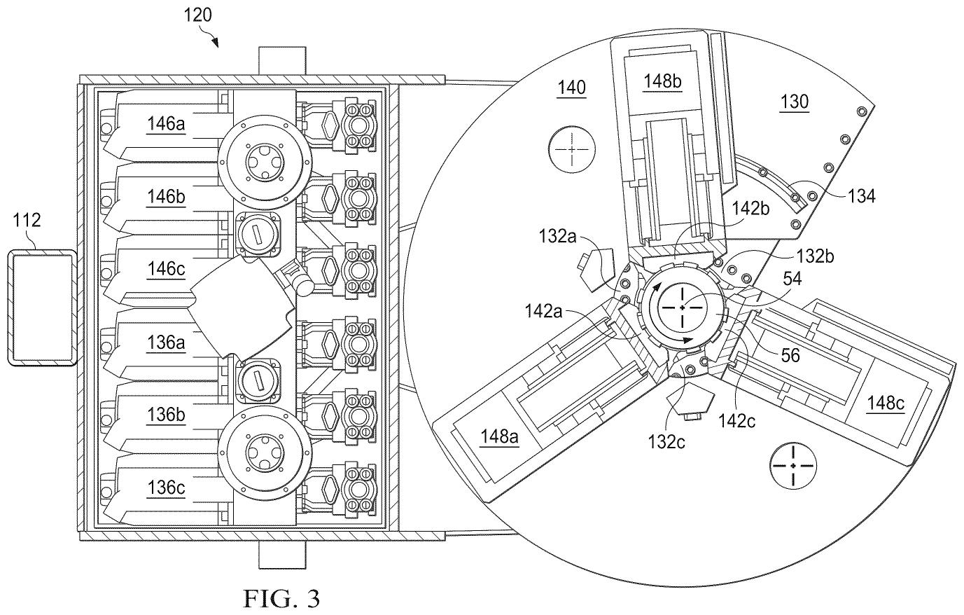

FIG. 3 is a representative partial cross-sectional top view of a wrench assembly 120 of an iron roughneck system 100 with a threaded connection joint 56 positioned therein and showing a plurality of hydraulic booster systems 146a-c, 136a-c in a sealed chamber and hydraulic actuators 148a-c of the torque wrench 140, in accordance with certain embodiments. Grippers 142a-c of the hydraulic actuators 148a-c are shown engaged with the lower portion 55 of the threaded connection joint 56, such that the lower portion 55 of the joint 56 is held stationary from rotating with the torque wrench 140 and remains rotationally fixed to a backup tong 130 as long as the grippers 142a-c remain engaged with the lower portion 55 of the joint 56. The grippers 132a-c are shown engaged with the upper portion 57 of the threaded connection joint 56 and function to rotate the upper portion 57 (of tubular stand 54) to thread/unthread it from the lower drill string 58.

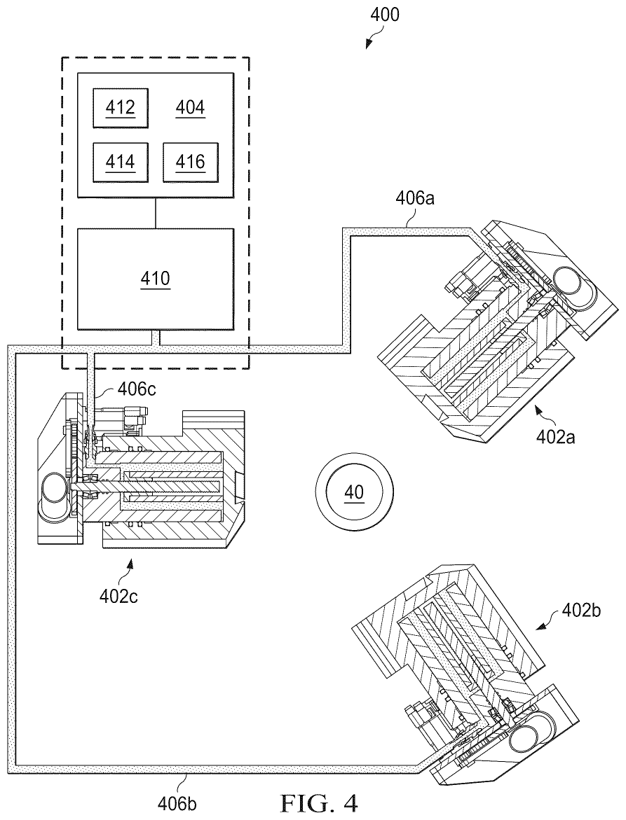

Now turning to FIG. 4, there is illustrated a block diagram/schematic view of an actuation system 400, in accordance with certain embodiments of the present disclosure, for use in the application of one or more forces to a target object (or body) 40. For example, the target object 40 may be the tubular stands 54 of FIGS. 1-3. The hydraulic actuators shown in the actuation system 400 may be used for the hydraulic actuators 148a-148c in the torque wrench assembly of the iron roughneck system 100 as described above and in FIGS. 1-3.

As shown in FIG. 4, the actuation system 400 includes one or more two-stage actuator units 402 (402a, 402b, 402c), a controller 404, and a hydraulic booster system 410 coupled in fluid communication with each of the two-stage actuator units 402 via one or more supply/return lines 406 (406a, 406b, 406c), respectively. The hydraulic booster system 410 is configured to output a supply flow of hydraulic fluid to the two-stage actuator units 402 via the supply/return lines 406 and receive a return flow of hydraulic fluid from the two-stage actuator units 402 via the supply/return lines 406, as well as apply or increase pressure to the hydraulic fluid in the lines 406. In the embodiment shown, each of the supply/return lines 406a, 406b, 406c provide bidirectional flow capabilities during operation. In other embodiments, separate supply and return lines may be used.

As will be appreciated, the actuation system 400 may include any number of two-stage actuator units 402 as required or suitable for a particular application. In one example, the actuation system 400 includes three two-stage actuator units 402a, 402b, 402c that each provide a clamping force exerted on the target object 40 at different locations/points. It will be understood that the two-stage actuator units may be operated and controlled independently or together. In some embodiments, each of the three actuator units 402 are disposed about at different locations around a center point at 120 degrees from each other. Other configurations may be utilized as desired.

The actuation system 400 may also include a controller 404 configured to control various operations of the actuation system 400, including the actuation units 402 and hydraulic booster system 410. The controller 404 generally includes a central processing unit (CPU) 412, memory 414, and other support circuitry 416. The CPU 412 may be one of any form of a general purpose processor that can be used in an industrial setting. The memory 414, which may include non-transitory computer-readable medium, is accessible by the CPU 412 and may be one or more of memory such as random access memory (RAM), read only memory (ROM), hard disk, or any other form of digital storage, local or remote. The support circuitry 416 are coupled to the CPU 412 and may comprise cache, clock circuits, input/output subsystems, control lines, power supplies, and the like. The various methods disclosed herein may generally be implemented under the control of the CPU 412 by the CPU 412 executing computer instruction code stored in the memory 414 as, for example, firmware or software. It will be understood that the controller 404 is configured to control operation(s) and action(s) of the actuators 402 and the hydraulic booster system 410. The controller 404 is configured to control various components, including for example, activating and deactivating an electric motor in the two-stage actuator units 402, and activating and deactivating an electrical motor or other actuator unit(s) in the hydraulic booster system 410 for providing high pressure hydraulic fluid to the two-stage actuator units 402.

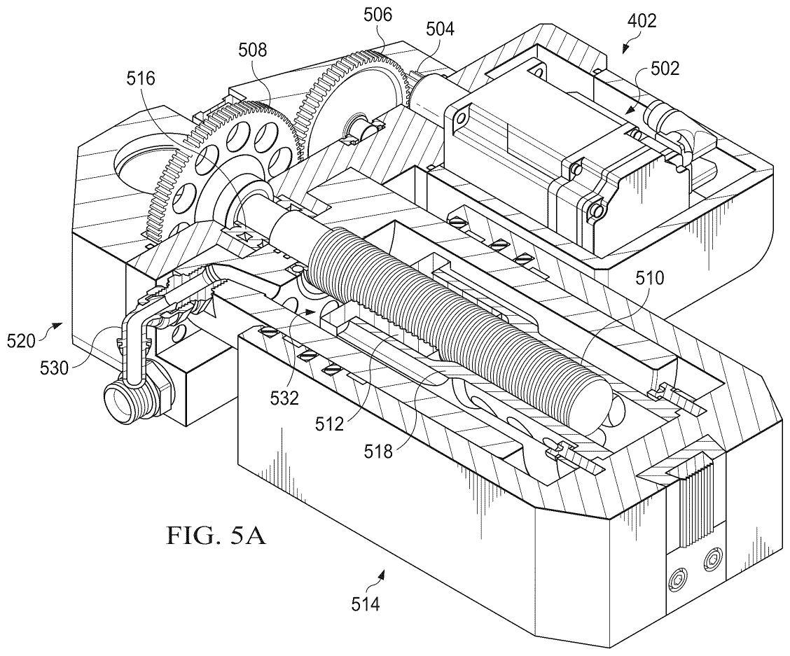

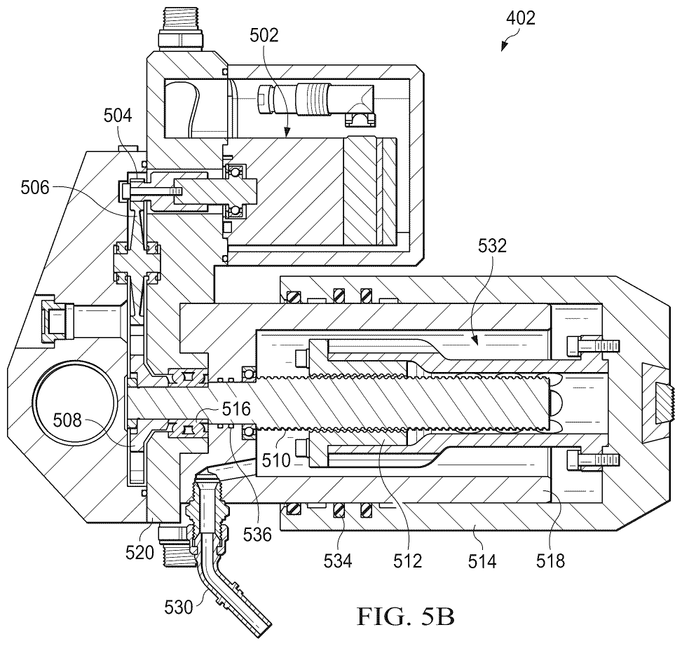

FIG. 5A illustrates a perspective, cross-sectional view of an example two-stage actuator unit 402, according to certain embodiments. FIG. 5B illustrates a schematic, cross-sectional top view of the two-stage actuator unit 402 of FIG. 5A, according to certain embodiments.

With reference to FIGS. 5A and 5B, the two-stage actuator unit 402 includes an electric motor 502 with a gear system, including a pinion gear 504, a spacing gear 506, and a working gear 508. When activated, the electric motor 502 drives the pinion gear 504 which drives the spacing gear 506 which drives the working gear 508. The working gear 508 is coupled to and drives rotation of a ball screw 510. A ball screw nut 512 is coupled to and engages with the threads of the ball screw 510. As the ball screw 510 rotates, the ball screw nut 512 displaces or moves along a longitudinal axis of the ball screw 510. The ball screw nut 512 is coupled to an outer housing/body 514 (also referred to herein as “clamping body 514”) such that as the ball screw nut 512 moves (in response to rotation of the ball screw 510) the outer housing/body 514 moves in tandem therewith and moves in the same longitudinal direction. Although the ball screw 510 is shown with the pinion gear 504 and the spacing gear 506, other gearing types may be used, such as a chain or belt, to drive the working gear 508.

The ball screw 510 is secured by a bearing arrangement 516 between a cylinder rod 518 and a housing 520. The outer housing/body 514 slidably engages the cylinder rod 518 and moves longitudinally along the cylinder rod 518 to extend or retract accordingly. As the outer housing/body 514 moves outward (extends), hydraulic fluid flows into the actuation unit 402 through a fluid connection 530 and into a fluid cavity 532 defined and bounded by the cylinder rod 518 (and the inner surface of the outer end of the outer housing/body 514. Similarly, as the outer housing/body 514 moves inward (retracts), hydraulic fluid flows out of the fluid cavity 532 and out of the actuation unit 402 through the fluid connection 530. The fluid connection 530 is coupled to the supply/return line 406 (see FIG. 4). The fluid is sealed within the fluid cavity 532 by one or more rod seals 534 disposed between the outer surface of the cylinder rod 518 and the inner surface of the outer housing/body 514, and by one or more rotary seals 536 disposed between the ball screw 510 and a surface of the cylinder rod 518.

With little to no pressure placed on the hydraulic fluid in the supply/return line 406, as the outer housing/body 514 moves outward (extension) by electrical actuation of the ball screw 510 in one direction of rotation, fluid is pushed into the fluid cavity 532, e.g., the hydraulic fluid is pushed into the fluid cavity 532, and supplied via the fluid connection 530 (from line 406 and its source, e.g., an accumulator or reservoir). And, as the outer housing/body 514 moves inward (retraction) by electrical actuation of the ball screw 510 in the opposite direction of rotation, fluid is pushed or drained, completely or partially, from the fluid cavity 532 and returned via the fluid connection 530 (to line 406).

In a first stage of actuation (referred to as electric actuation), the outer housing/body 514 moves from an unclamped position (e.g., retracted) to a pre-clamping position (extended), e.g., when the outer housing/body 514 contacts the target object or reaches a pre-determined distance from the target object 40. After completion of the first stage, a second stage of actuation (referred to as hydraulic actuation or static force amplification) is performed. At this time, external high pressure is applied to the hydraulic fluid in the line 406 (e.g., via the hydraulic booster system 410) which simultaneously introduces additional fluid and/or high pressure to the fluid in the fluid cavity 532, and which in turn applies additional force (extension) on the outer housing/body 514 and the target object 40. When the desired hydraulic pressure is achieved, the actuation unit 402 is considered to be in a clamping position. This allows the actuation unit 402 to achieve a higher force without relying on additional force to be applied by the electrical motor 502, e.g., via the ball screw 510. This may reduce power consumption and further reduce the size and costs of the electric actuation components (e.g., smaller ball screw 510 and related components) of the actuation unit 402 which would have normally been required to produce the required high forces needed for clamping.

When the second stage clamping force is no longer required, removal of the external high pressure applied to the hydraulic fluid in the line 406 (e.g., via the hydraulic booster system 410) is performed. This results in removing or reducing the high pressure currently applied to the fluid in the fluid cavity 532 (and the pressure applied to the outer housing/body 514). Once the pressure of the hydraulic fluid in the line 406 (and at the fluid connection 530) is reduced to no or little pressure, the electrical motor 502 is activated in the reverse direction causing the ball screw 510 to rotate and move (retract) the outer housing/body 514 to a predetermined unclamped position or state. As described above, retraction of the outer housing/body 514 by the electrical motor 502 causes the fluid in the fluid cavity 532 to return to the line 406. For example, the electrical motor 502 may rotate such that the clamping body 514 is back at an initial position, e.g., the ball screw nut 512 is contacting a base of the cylinder rod 518, effectively removing most if not all of the fluid from the cavity 532.

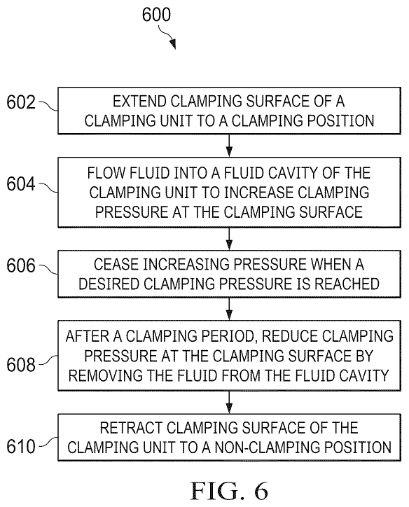

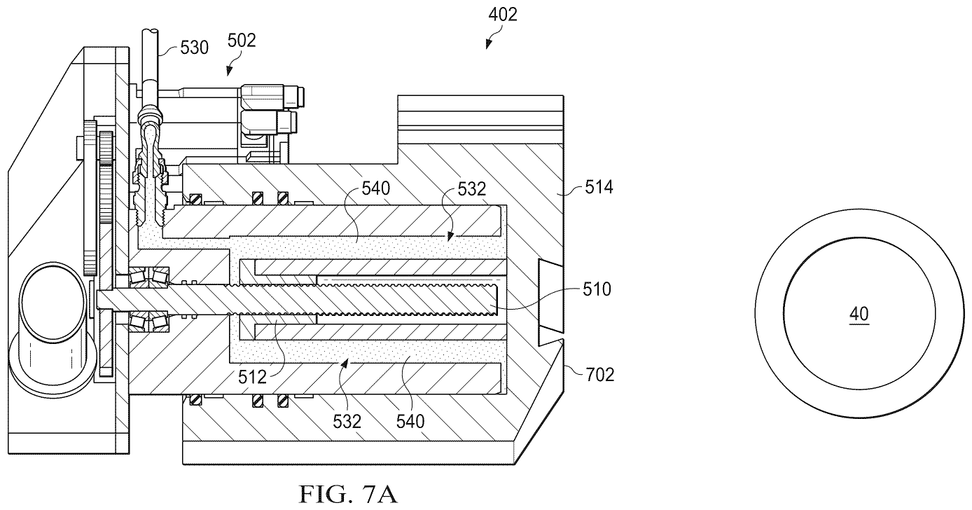

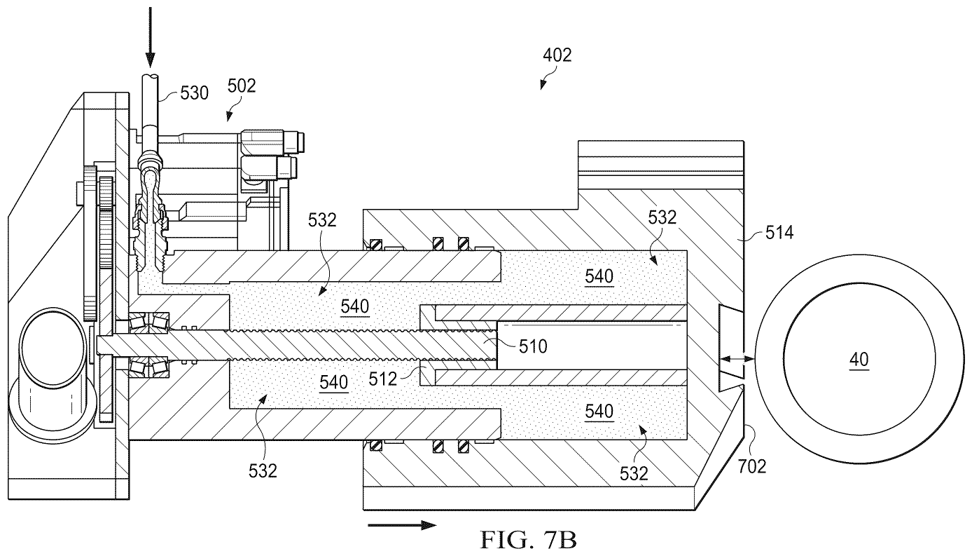

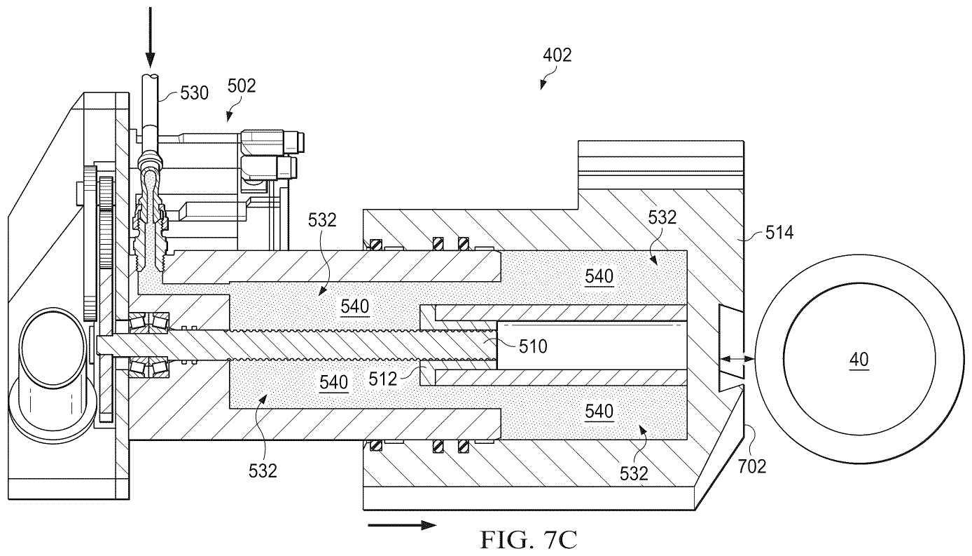

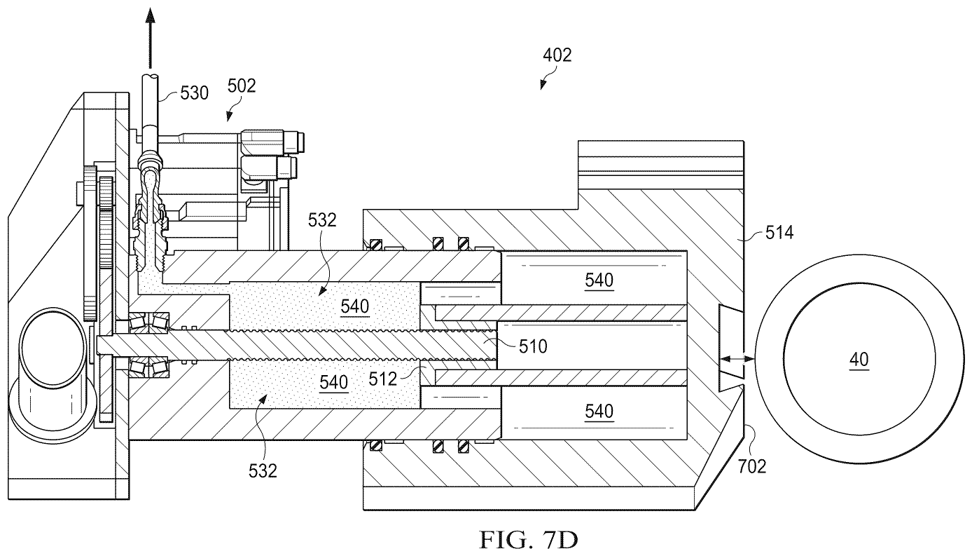

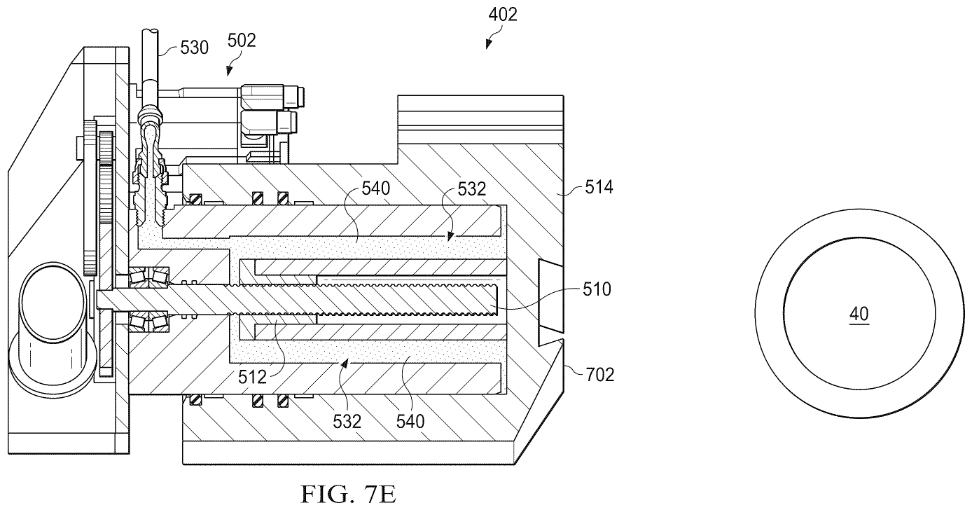

FIG. 6 illustrates a flow diagram of a method 600 of performing a clamping operation using one or more of the clamping two-stage actuator units 402, according to certain embodiments. FIGS. 7A-7E illustrate an example clamping two-stage actuator unit 402 undergoing the method 600 of FIG. 6, according to certain embodiments. For example, the method 600 may be executed using the clamping actuation system 400 of FIG. 4 having the clamping two-stage actuator units 402 of FIGS. 5A and 5B.

With reference to FIG. 7A, there is shown the clamping actuation unit 402 in an unclamped position or state and a contact surface 702 of the clamping body 514 is a predetermined distance from the target object 40. Hydraulic fluid 540 in the line 406 is under little or no pressure and is disposed within the fluid cavity 532 (supplied via the connection 530).

The method 600 begins at step 602 during which the actuation unit 402 operates in a first stage of actuation (referred to as electric actuation). The outer housing/body 514 moves from the unclamped position (e.g., retracted) as shown in FIG. 7A to a pre-clamping position (extended) as shown in FIG. 7B in response to operation/activation of the electric motor 502. During operation, the electric motor 502 causes the ball screw 510 to rotate which in turn moves/extends the outer housing/body 514 and the contact surface 702 toward the target object 40. As described above, during this mechanical movement of the outer housing/body 514, the fluid cavity 532 increases in volume subsequently drawing additional hydraulic fluid into the fluid cavity 532 (supplied via the fluid connection 530). This extended pre-clamping position may be a desired fixed position, such as a preset distance from the initial unclamped position or a short distance from the target object 40, until contact is made with the target object 40, or until a desired clamping pressure (e.g., relatively small) is applied to the target object 40 by the contact surface 702.

With reference to FIG. 7C, after completion of the first stage (step 602), the actuation unit 402 operates in a second stage of actuation (referred to as hydraulic actuation or static force amplification) in step 604. External high pressure is applied to the hydraulic fluid 540 in the line 406 (e.g., via the hydraulic booster system 410) which simultaneously introduces additional fluid and/or high pressure to the fluid in the fluid cavity 532, and which in turn applies additional force (extension) on the outer housing/body 514 and the target object 40. In the example clamping system 400, pressure of the fluid 540 is increased and maintained in the system to impart the desired clamping force on the target object 40. The amount of applied pressure will depend on the desired force and particular application.

This increases the pressure/force of the fluid 540 in the fluid cavity 532 and applies an outward force to the outer housing/body 514 and against the target object 40. When used in a clamping system, the additional force applied, e.g., hydraulic force, increases the clamping pressure applied at the target object 40 without requiring the electric motor 502 to further rotate the ball screw 510. The use of the fluid 540 to apply increased clamping pressure at the target object 40 reduces the power requirement for the electric motor 502 as the electric motor 502 does not need to apply (and usually cannot supply) the full clamping force required at the target object 40 as would be needed in purely electrical clamping systems. The reduction in the power requirement from the electric motor 502 allows for a smaller, more efficient motor to be utilized in the clamping two-stage actuator unit 402. Additionally, using the electric motor 502 to place the outer housing/body 514 in a pre-clamping position against the target object 40, e.g., a pipe or tubular member of a drilling system, allows for increased speed and accuracy of placement over purely hydraulic clamping systems.

The fluid pressure and subsequent clamping pressure may be maintained by the clamping actuation unit 402 for a clamping period, e.g., a desired length of time for which to clamp or secure the target object 40. When the clamping pressure is no longer desired, the externally applied high pressure in line 406 is reduced/removed, at a step 606.

With reference to FIGS. 7D and 7E, at a step 608 (reverse of step 602), the electric motor 502 is operated in the reverse direction—causing the outer housing/body 514 to move from the pre-clamping position back to the unclamped position as shown in FIG. 7E. During operation, the electric motor 502 causes the ball screw 510 to rotate which in turn moves/retracts the outer housing/body 514 and the contact surface 702 away from the target object 40. As described above, during this mechanical movement of the outer housing/body 514, the fluid cavity 532 reduces in volume and hydraulic fluid 540 flows or drains from the fluid cavity 532 through the fluid connection 530 back into the line 406. As will be appreciated, the fluid 540 may be fully drained from the fluid cavity 532 if desired. Alternatively, the fluid 540 may still fill the reduced volume of the fluid cavity 532 and ready for the next clamping cycle.

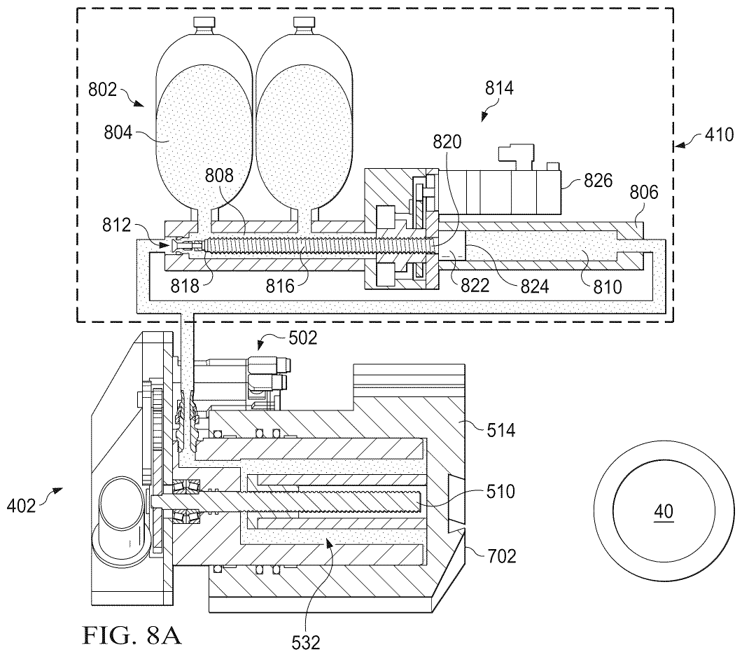

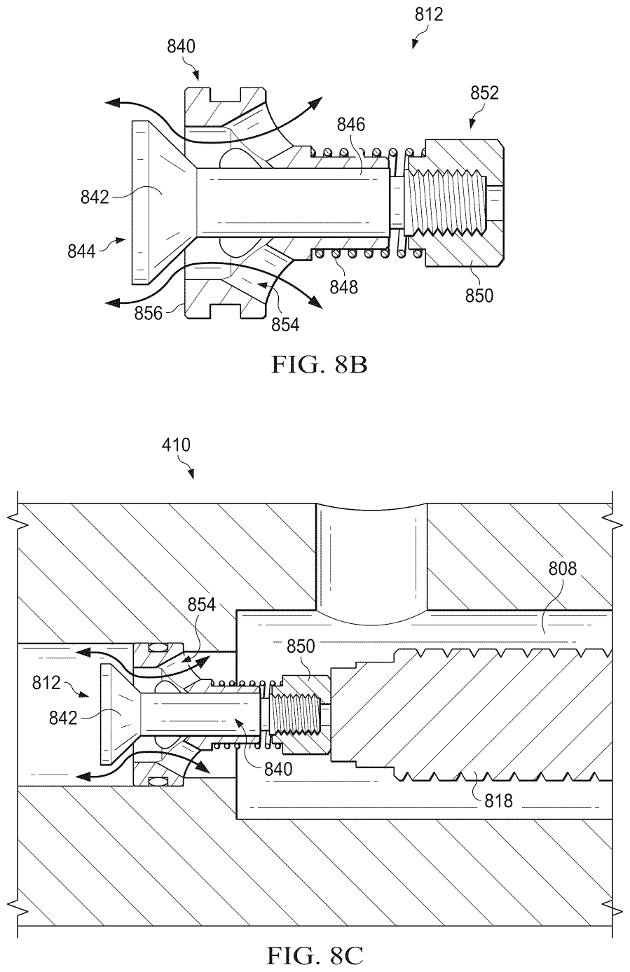

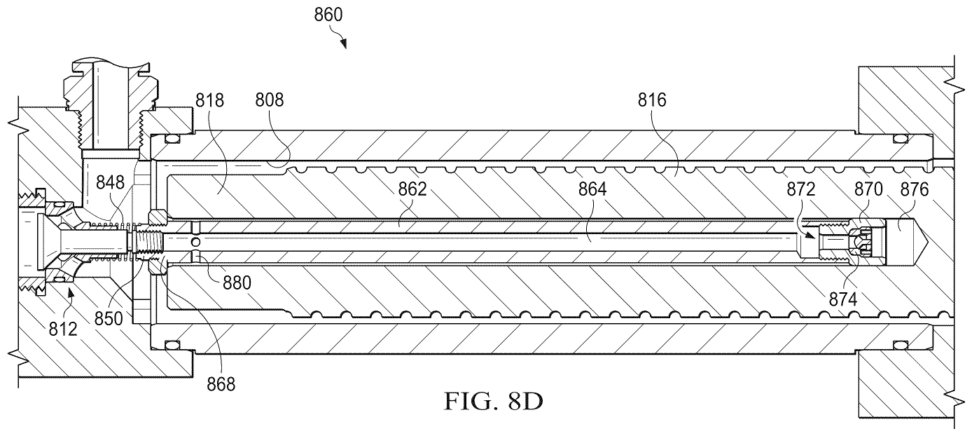

Now turning to FIG. 8A, there is illustrated a simplified schematic view of an example hydraulic booster system 410, according to certain embodiments. The hydraulic booster system 410 includes an accumulator 802 configured to hold a fluid 804, and an amplifier body 806. The amplifier body 806 includes a first volume or cavity 808 and a second volume or cavity 810. A check valve 812 is disposed between the first volume 808 and an output of the body 806 coupled to the fluid line(s) 406 and is configured to allow the fluid 804 to selectively flow between the first volume 808 and the fluid line(s) 406 of the clamping system 400. A screw actuator 814 is disposed within the first volume 808 and the second volume 810 of the amplifier body 806. The screw actuator 814 includes a screw body 816 having a first end 818 disposed within the first volume 808 and a second end 820 disposed within the second volume 810. The screw actuator 814 includes a pressing body 822 having a pressing surface 824 disposed on the second end 820. A booster motor 826 is coupled to the screw actuator 814 and is configured to drive or translate the screw actuator 814 to move axially along the length of the amplifier body 806.

In FIG. 8A, the hydraulic booster system 410 is shown fluidly coupled to one of the two-stage actuator units 402 by one of the plurality of fluid lines 406. In other embodiments (e.g., FIG. 4), the hydraulic booster system 410 is fluidly coupled to each of the two-stage actuator units 402a, 402b, 402c by the plurality of fluid lines 406a, 406b, 406c. The hydraulic booster system 410 is configured to flow and pressurize (apply pressure) the fluid 804 within the fluid line(s) 406 and, ultimately, within the two-stage actuator unit(s) 402. As will be appreciated, the two-stage actuator unit 402 is the same or similar to the two-stage actuator unit 402 described above with respect to FIGS. 5A, 5B, 6 and 7A-7E. It will be understood that the fluid 804 of the hydraulic booster unit 410 is the same as the fluid 540 shown within the actuation units 402 (see, FIGS. 7A-7E).

FIG. 8B illustrates a schematic, cross-sectional view of the check valve 812 of the hydraulic booster system 410 of FIG. 8A, according to certain embodiments. FIG. 8C illustrates a schematic, cross-sectional view of a portion of the hydraulic booster system 410 of FIG. 8A, according to certain embodiments. In particular, FIG. 8B illustrates an exemplary check valve 812 and FIG. 8C illustrates the exemplary check valve 812 disposed between the first volume 808 of the amplifier body 806 and an output of the body 806 coupled to the fluid line(s) 406.

With reference to FIG. 8B, the check valve 812 includes a valve body 840 having a valve inner head 842 on a first valve end 844 of a valve stem 846. A spring 848 is coaxially disposed about the valve body 840 and in contact with a valve protrusion 850 on a second valve end 852 of the valve stem 846 opposite the first valve end 844 and disposed in the first volume 808. When the spring 848 is compressed, e.g., the valve protrusion 850 applies a compressive force onto the spring 848, the valve inner head 842 translates such that a valve opening passageway 854 is created between the valve inner head 842 and a valve outer head 856 of the valve body 840. In basic operation, the check valve 812 is in a normally closed position and applying sufficient pressure on the valve protrusion 850 opens the check valve 812 enabling fluid to flow therethrough. It will be understood that different types and configurations of check valves may be implemented to provide the flow/no flow functionality.

With reference to FIG. 8C, as the first end 818 of the screw body 816 applies pressure on the valve protrusion 850, the spring 848 compresses, the valve opening passageway 854 allows for flow of the fluid 804 from the first volume 808 into the fluid line(s) 406 or from the fluid line(s) 406 into the first volume 808, depending on the stage of the clamping process of the clamping system 400. As will be appreciated, when the check valve 812 is closed, fluid 804 is prevented from flowing between the fluid line(s) 406 and the first volume 808. In this state, pressure may be applied to the fluid 804 in the fluid line(s) 406 (e.g., by applying pressure to the fluid in the second volume 810).

FIG. 8D illustrates a schematic, cross-sectional view of an alternative check valve mechanism and arrangement 860 which may be used in the hydraulic booster system 410 of FIG. 8A, according to certain embodiments. In particular, the first end 818 of the screw body 816 (of FIG. 8C) has been modified to include a secondary check valve 870.

With reference to FIG. 8D, a first end 818 of the screw body 816 includes an inner, annular channel or cavity 876 formed therein, as shown. Within the channel cavity 867 is disposed a tube 862 having an inner annular channel 864 and having passageways 880 extending from the inner channel 864 through sidewalls to the exterior of the tube 862 One end 868 of the tube 862 is coupled to the valve protrusion 850 of the main check valve 812, while the other end 872 is coupled to the secondary check valve 870 and disposed in the channel or cavity 876.

During extension of the two-phase actuator system, the fluid 804 (FIG. 8A) enters the tube 862 through the passageways 880 and flows to the secondary check valve 870. The secondary check valve 870 at this stage is open and allows for the hydraulic flow to pass from the inner annular channel 864 into the cavity 876, building pressure within the cavity 876, assisting the screw body 816 to extend (toward the right in FIG. 8D).

As the screw body 816 begins extending (toward the right in the FIG. 8D), pressure (in the direction to the left) applied to the tube 862 is removed which applies pressure on the spring 848 of the main check valve 812 causing the check valve closes (e.g., as shown in the position illustrated in FIG. 8D). As the screw body 816 continues extending to the right, the first end 818 moves past the passageways 880 and fluid within the cavity 808 may flow into the inner channel 864 of the tube 862 through the secondary check valve 870 into the cavity 876.

As the screw body 816 begins retracting (moving to the left) from the extended position, the gap between the secondary check valve 870 and the cavity 876 allows for pressure to build in the cavity 876. When the force from the tube 862 (e.g., applied by the increasing pressure in the cavity 876) will eventually exceed the force applied by the spring 848 on the main check valve 812, e.g., pushing the tube 862 to compress the spring 848, allowing the main check valve 812 to open, dropping the pressure which, in turn, allows for the two-stage actuator 402 to be retracted.

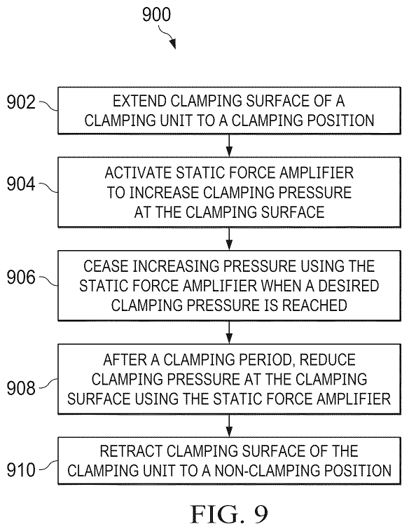

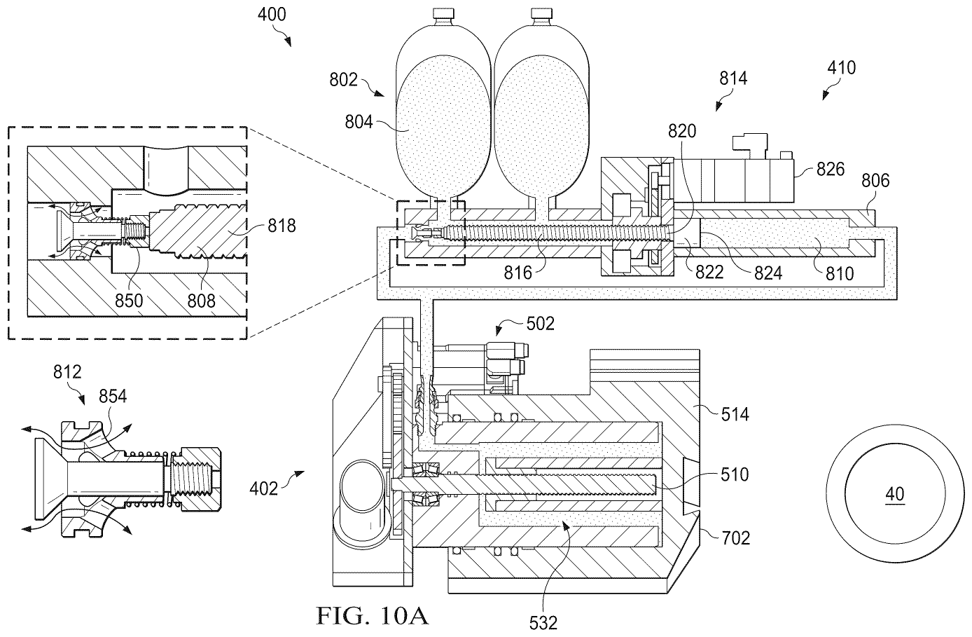

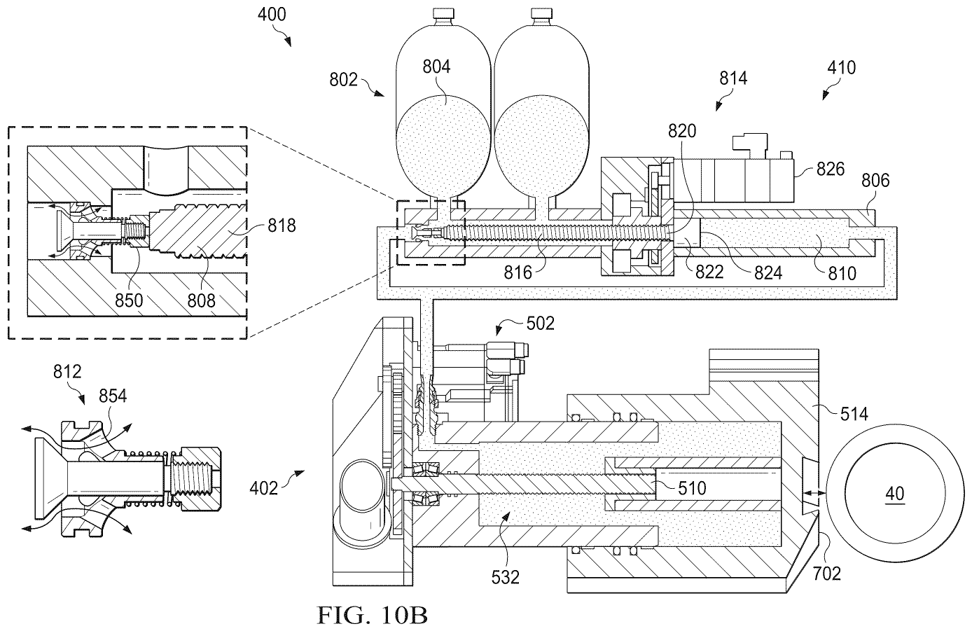

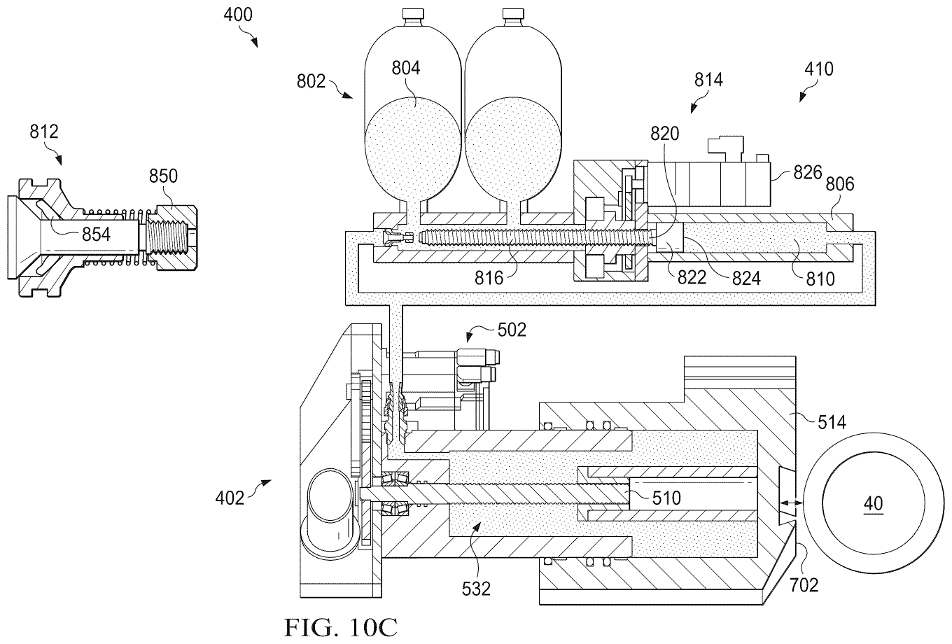

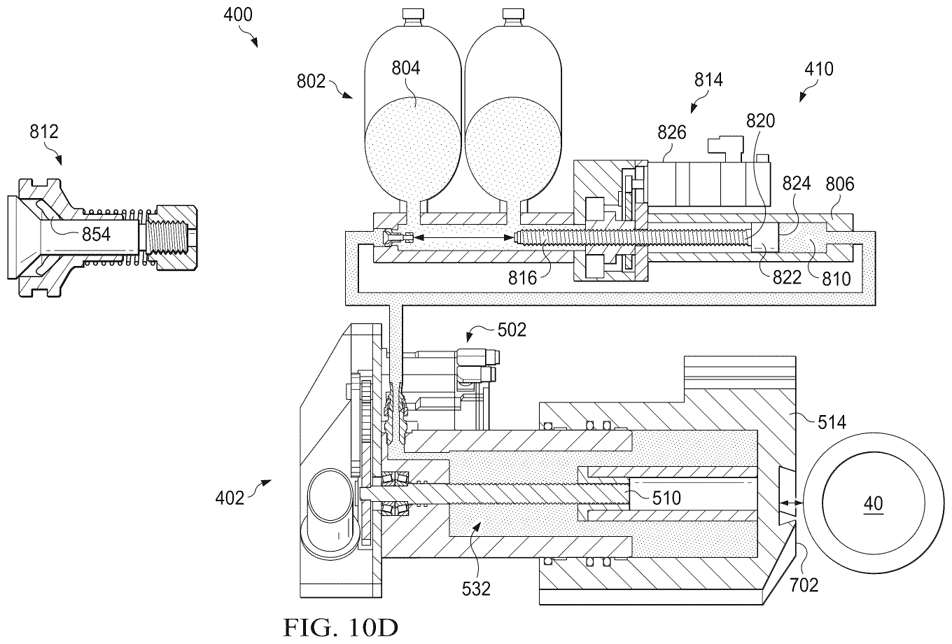

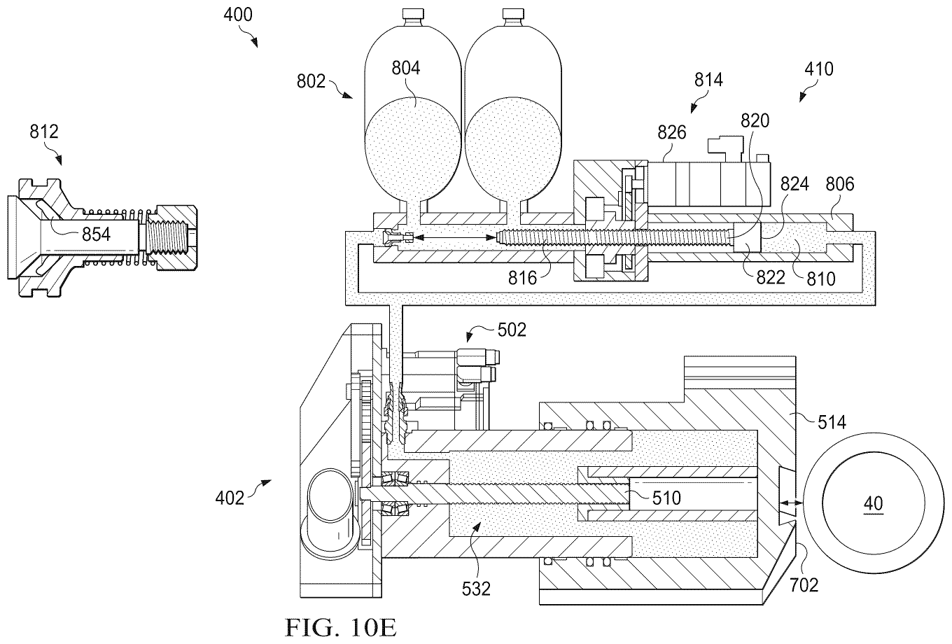

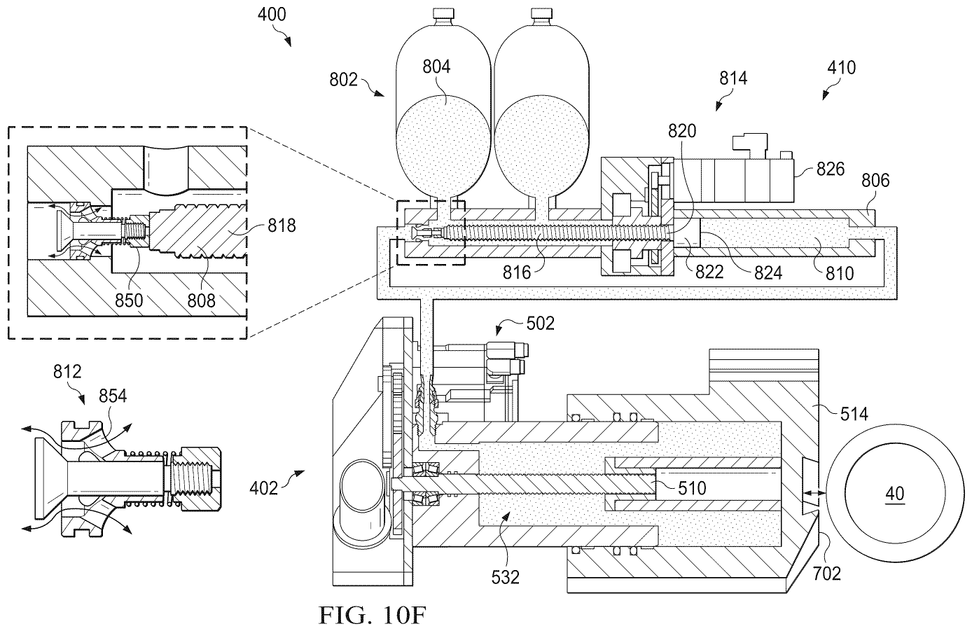

FIG. 9 illustrates a flow diagram of a method 900 of providing high pressure to a fluid system using a hydraulic booster unit, according to certain embodiments. FIGS. 10A-10F illustrate an actuation system generating high pressure fluid actuation pursuant to the method 900 of FIG. 9, according to certain embodiments. For example, the method 900 may be executed using the actuation system 400 of FIG. 4 having the hydraulic booster system 410 of FIG. 8A and illustrating only one actuation unit 402 for exemplary purposes.

FIG. 10A shows the actuation system 400 in a steady-state or unclamped position, and the two-stage actuator unit 402 is in an unclamped state or position. In this state, the screw body 816 is in a retracted position, the check valve 812 is in an open position, and fluid 804 may flow from/to the accumulators 802 to/from the fluid line(s) 406. In this state, there is relatively low pressure within the fluid system and fluid 804 is disposed within the first and second volumes 808, 810 and within the two-stage actuator unit(s) 402, as shown.

With reference to FIG. 10B, the clamping body 514 (and the clamping surface 402) of the clamping two-stage actuator unit 402 is extended, in a step 902, to a pre-clamping position from an initial unclamped (e.g., steady-state or retracted) position shown in FIG. 10A. For example, the clamping body 514 may be extended to the pre-clamping position from the unclamped position before being operated in the clamping position. The pre-clamping position may be a desired fixed position, such as a preset distance from the initial unclamped position (or preset distance from the target object 40), when contact is made with the target object 40, or until a relatively low clamping pressure is applied to the target object 40 by the clamping surface 402 of the clamping body 514 resulting from the mechanical pressure applied to the clamping body 514 by the motor 502 and ball screw 510.

Extending the clamping surface 702 of the two-stage actuator unit 402 to the pre-clamping position may include activating the electric clamping motor 502 to rotate the ball screw 510 to extend the clamping body 514 to the pre-clamping position, e.g., the first stage of actuation or electric actuation as described above (see, FIG. 4B and accompanying description). The accumulator 802 provides a supply of the fluid 804, e.g., through the check valve 812 and the fluid line(s) 406 to fill the fluid cavity 532 as the clamping body 514 moves toward the target object 40. This reduces the amount of fluid 804 in the accumulator 802 from an initial fluid level (FIG. 10A) to a reduced level (FIG. 10B).

Once the first stage actuation (electric or electromechanical actuation) is complete, the second stage actuation (hydraulic actuation) is activated, in a step 904, With reference to FIG. 10C, the hydraulic booster system 410 is activated in step 904 to increase or apply hydraulic pressure to the fluid 804 in the fluid line(s) 406 which is applied to the clamping body 514 of the two-stage actuator unit 402. As shown in FIG. 10C, the booster motor 826 is activated which activates the screw actuator 814 thereby causing the screw body 816 to move in the lateral direction to the right (in FIG. 10C). As the screw body 816 is driven and begins to move to the right, the check valve 812 closes and the pressing body 822 begins extending into the second volume 810 and applying force onto the fluid 804 disposed within the second volume 810. As this occurs, the first end 818 releases pressure from the valve protrusion 850 due to translation of the screw body 816 creating a gap between the valve protrusion 850 and the screw body 816. This gap allows the spring 848 to decompress which closes the valve opening passageway 854 with the valve inner head 842. The closure of the valve opening passageway 854 prevents the flow of the fluid 804 into or out of the first volume 808, creating a closed fluid system within the fluid line(s) 406.

As the screw body 816 continues moving to the right as shown in FIG. 10D, the force applied to the fluid 804 within the second volume 810 increases the pressure of the fluid 804 within the closed fluid system and increases the hydraulic pressure applied to the clamping body 514 causing the clamping surface 702 to increase the force applied onto the target object 40. As described above, this step of the method is referred to as “static force amplification.” When the desired clamping force is achieved, the booster motor 826 is deactivated, at a step 906, and the screw body 816 stops moving and is in a static position for a period of time (a clamping period, e.g., a desired length of time for which to clamp the target object 40). The fluid pressure and subsequent clamping pressure may be maintained by the hydraulic booster system 410 and the two-stage actuator unit 402 for the clamping period. As will be appreciated, the hydraulic booster system 410 may be configured to operate the booster motor 826 for a predetermined period of time or until a predetermined pressure is achieved in the fluid system (as measured by a hydraulic pressure sensor disposed at a point in the system and sent/input to the hydraulic booster system 410 or controller 404). In this state, the clamping body 514 (and unit 402) is operating in the clamping position.

With reference to FIG. 10E, after a clamping period, the clamping pressure at the clamping surface 702 is reduced in a step 908 using the hydraulic booster system 410. For example, the booster motor 826 is activated causing the screw body 816 to begin moving in the lateral direction to the left (in FIG. 10E) and the pressing body 822 begins retracting from the second volume 810 and reducing a force applied to the fluid 804 in the second volume 810, thereby reducing pressure applied to the fluid 804 in the second volume 810. While this occurs, the clamping pressure at the clamping surface 702 is concurrently reduced. As the screw body 816 continues moving to the left as shown in FIG. 10E, the first end 818 of the screw body 816 engages with, e.g., presses, the valve protrusion 850 of the check valve 812. When the screw body 816 presses against the valve protrusion 850, the valve inner head 842 translates, opening the valve opening passageway 854 such that fluid 804 may flow from the fluid line(s) 406 into the first volume 808 of the amplifier body 806, further relieving fluid pressure within the actuation system 400. The booster motor 826 is deactivated and the screw body 816 reverts back to the pre-clamping position. As will be appreciated, the system has returned to the pre-clamping position, as shown in FIG. 10F, and the hydraulic actuation stage (or static force amplification) is complete. During the hydraulic actuation stage, the clamping body 514 (and clamping surface 402) does not move, or moves only a short distance (e.g., about ½ inch or less).

With continued reference to FIG. 10F, the clamping body 514 (and clamping surface 402) of the two-stage actuator unit 402 is retracted from the pre-clamping position to the unclamped position, in a step 910. For example, as described above, the pre-clamping position may be a desired fixed position, such as a preset distance from the initial unclamped position (or preset distance from the target object 40), contact with the target object 40, or until a relatively low clamping pressure is applied to the target object 40 by the clamping surface 402 of the clamping body 514.

Retracting the clamping body 514 of the two-stage actuator unit 402 to the unclamped position may include activating the electric clamping motor 502 in a reverse direction to rotate the ball screw 510 to retract the clamping body 514 to the unclamped position, e.g., reverse of the first stage of actuation or electric actuation as described above (see, FIG. 7E and accompanying description). As the clamping body 514 retracts, the fluid within the fluid cavity 532 is forced into the fluid line(s) 406 which, in turn, flows back to the hydraulic booster system 410 through the check valve 812 into the first volume 808 and into the accumulator 802—returning the system 400 back to the unclamped position or state as shown in FIG. 10A and completing a clamping cycle.

The present disclosure provides for a hybrid actuation unit using both electric actuation (electric motor for mechanical movement/clamping) and high-pressure hydraulic fluid (hydraulic system for clamping force). This enables implementation of a small electric motor and achievement of high static hydraulic pressure. The present disclosure further provides systems and methods that passively feed any clamping unit from the accumulator while providing high static pressure when desired. Further, the actuation unit is electrically driven in a first stage for speed and accurate positioning against a target object.

When introducing elements of the present disclosure or exemplary aspects or embodiments thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another—even if objects A and C do not directly physically touch each other. For instance, a first object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A hydraulic booster unit for applying pressure to hydraulic fluid disposed within an actuation system, the hydraulic booster unit comprising:
an amplifier body comprising,
an actuator having a first end disposed within a first volume and a second end disposed within a second volume,
a first fluid connection coupled to the first volume and configured to selectively provide fluid connection between the first volume and an actuation system, the first fluid connection comprising a check valve,
a second fluid connection coupled to the second volume and configured to provide fluid connection between the second volume and the actuation system, and
a motor configured to axially move the actuator along a length of the amplifier body and apply pressure to hydraulic fluid within the second volume; and
an accumulator configured to hold hydraulic fluid and supply hydraulic fluid to the first volume.

2. The hydraulic booster unit of claim 1, wherein the hydraulic booster unit further comprises a check valve disposed within the first volume and configured to allow the fluid to flow from the accumulator.

3. The hydraulic booster unit of claim 2, wherein the check valve comprises:
a valve body having a valve inner head on a first valve end of a valve stem; and
a spring disposed about the valve body and in contact with a valve protrusion on a second valve end of the valve stem, the second valve end disposed within the first volume.

4. The hydraulic booster unit of claim 1, wherein the actuator comprises a screw body having a first end disposed within the first volume and a second end disposed within the second volume.

5. The hydraulic booster unit of claim 1, wherein the actuator is coupled to a secondary check valve.

6. The hydraulic booster unit of claim 5, wherein the secondary check valve is disposed in a cavity of the actuator on an opposite end of the check valve.

7. The hydraulic booster unit of claim 6, wherein the secondary check valve is configured to allow the fluid to flow into the cavity.

8. An actuation system, comprising:
one or more two-stage actuator units comprising:
an electrical motor;
a ball screw coupled to the electrical motor; and
a clamping body coupled to the ball screw;
a hydraulic booster unit fluidly coupled to the one or more two-stage actuator units and comprising:
an accumulator configured to contain a fluid;
an amplifier body having a first volume and a second volume fluidly coupled to the accumulator; and
a screw actuator disposed within the first volume and the second volume.

9. The actuation system of claim 8, wherein the hydraulic booster unit further comprises a check valve disposed within the first volume and configured to allow the fluid from the accumulator to flow from the first volume into a plurality of fluid lines of the actuation system.

10. The actuation system of claim 9, wherein the check valve comprises:
a valve body having a valve inner head on a first valve end of a valve stem; and
a spring disposed about the valve body and in contact with a valve protrusion on a second valve end of the valve stem, the second valve end disposed within the first volume.

11. The actuation system of claim 8, wherein the screw actuator comprises a screw body having a first end disposed within the first volume and a second end disposed within the second volume.

12. The actuation system of claim 11, wherein the screw actuator is coupled to a booster motor, the booster motor configured to translate the screw body axially along a length of the amplifier body.

13. The actuation system of claim 12, wherein the screw actuator comprises a pressing body having a pressing surface disposed on the second end.

14. The actuation system of claim 13, wherein the booster motor is configured to rotate a screw body such that the pressing body applies a force onto a fluid disposed in the second volume.

15. A method of providing high pressure to a fluid system, comprising:
extending a clamping surface of a clamping body of a clamping unit to a clamping position;
activating a hydraulic booster unit to increase a clamping pressure at the clamping surface;
after a clamping period, reducing the clamping pressure at the clamping surface using the hydraulic booster unit; and
retracting the clamping surface of the clamping unit to a pre-clamping position.

16. The clamping method of claim 15, wherein extending the clamping surface of the clamping unit to the clamping position comprises using a clamping motor to rotate a ball screw to extend the clamping body to a pre-clamping position.

17. The clamping method of claim 16, wherein extending the clamping surface of the clamping unit to the clamping position comprises supplying a fluid from an accumulator to fill a fluid cavity to extend the clamping body to the clamping position.

18. The clamping method of claim 15, wherein activating a hydraulic booster unit to increase a clamping pressure at the clamping surface comprises using a booster motor of the hydraulic booster unit to rotate a screw actuator of the hydraulic booster unit to apply a force onto a fluid disposed within a second volume of the hydraulic booster unit, the second volume fluidly coupled to the clamping body of the clamping unit.

19. The clamping method of claim 15, wherein activating a hydraulic booster unit to increase a clamping pressure at the clamping surface comprises closing of a valve opening of a check valve disposed within the hydraulic booster unit to create a closed fluid system.

20. The clamping method of claim 19, wherein activating a hydraulic booster unit to increase a clamping pressure at the clamping surface comprises increasing a pressure of a fluid within the closed fluid system to increase the pressure applied at the clamping surface.
